(19) United States
(12) Patent Application Publication
(10) Pub. No.: US 2026/0179608 A1
(43) Pub. Date: Jun. 25, 2026

(54) BUSINESS NEGOTIATION EVALUATION METHOD

(71) Applicant: TOYOTA JIDOSHA KABUSHIKI KAISHA, Toyota-shi (JP)

(72) Inventors: Takuma SUZUKI, Tokyo (JP); Hideki Kawai, Tokyo (JP)

(73) Assignee: TOYOTA JIDOSHA KABUSHIKI KAISHA, Toyota-shi (JP)

(21) Appl. No.: 19/372,350

(22) Filed: Oct. 29, 2025

(30) Foreign Application Priority Data
Dec. 19, 2024 (JP) 2024-224476

(51) Int. Cl. G10L 15/18; G06Q 10/0639; G06Q 50/18

(52) U.S. Cl. CPC G10L 15/1822; G06Q 10/06393; G06Q 50/188

(57) ABSTRACT

A business negotiation evaluation method to be executed by an information processing device includes: acquiring voice data related to a business negotiation; extracting, from the voice data, a duration of product explanation, a timing to acquire personal information, details of questions asked when acquiring the personal information, and a timing to utilize the personal information for proposals during the business negotiation; and calculating and presenting information related to the duration and quantitative data related to the personal information.

### CROSS-REFERENCE TO RELATED APPLICATION

This application claims priority to Japanese Patent Application No. 2024-224476 filed on Dec. 19, 2024. The disclosure of the above-identified application, including the specification, drawings, and claims, is incorporated by reference herein in its entirety.

### BACKGROUND

### 1. Technical Field

The present disclosure relates to a business negotiation evaluation method.

### 2. Description of Related Art

Hitherto, there have been known technologies for analyzing details of business negotiations regarding products. For example, Japanese Unexamined Patent Application Publication No. 2019-28910 (JP 2019-28910 A) discloses a conversation analysis system that checks whether a sales representative explained matters that should be explained during a business negotiation with a customer and whether the sales representative did not mention matters that should not be mentioned.

### SUMMARY

Although JP 2019-28910 A discloses a technology for analyzing details of a business negotiation by machine learning, research has been insufficient about evaluation of details of a business negotiation and indication of points for improvement in the process of a business negotiation. Thus, there is room for improvement in the business negotiation evaluation technology.

In view of the above circumstances, an object of the present disclosure is to improve a business negotiation evaluation technology.

A business negotiation evaluation method according to an embodiment of the present disclosure is a business negotiation evaluation method to be executed by an information processing device. The business negotiation evaluation method includes:
acquiring voice data related to a business negotiation;
extracting, from the voice data, a duration of product explanation, a timing to acquire personal information, details of questions asked when acquiring the personal information, and a timing to utilize the personal information for proposals during the business negotiation; and
calculating and presenting information related to the duration and quantitative data related to the personal information.

According to the embodiment of the present disclosure, the business negotiation evaluation technology is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment; and

FIG. 2 is a flowchart showing an operation of an information processing device.

### DETAILED DESCRIPTION OF EMBODIMENTS

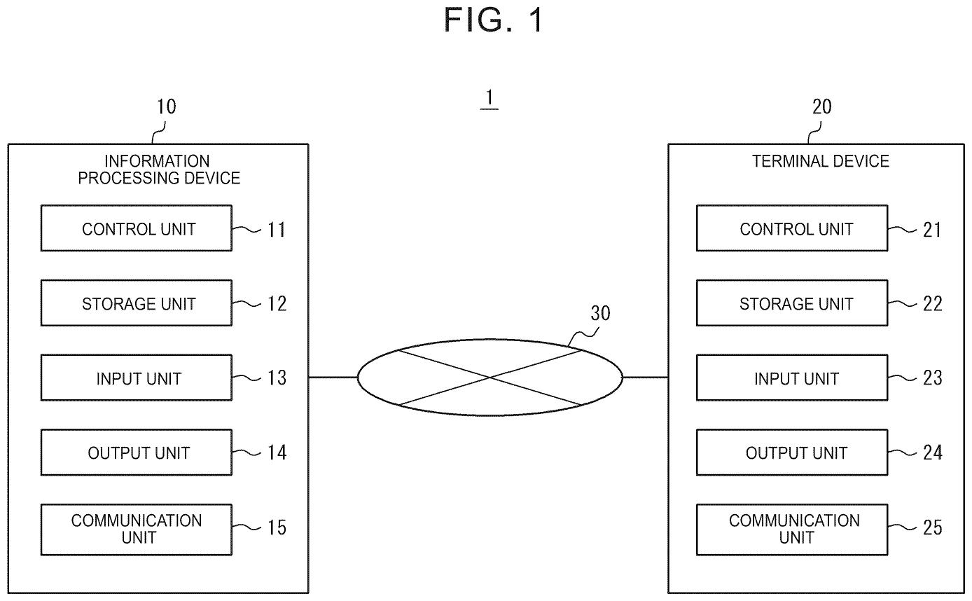

Hereinafter, an embodiment of the present disclosure will be described. The overview and configuration of a system 1 according to the present embodiment will be described with reference to FIG. 1. The system 1 according to the present embodiment includes an information processing device 10 and a terminal device 20. The information processing device 10 is, for example, a server device installed in a data center. The terminal device 20 is any device to be used by a user such as a sales staff member. These devices are communicatively connected via a network 30 such as the Internet. Although FIG. 1 shows one information processing device 10 and one terminal device 20, the system 1 may include a plurality of the devices.

The overview of the present embodiment will be described first, and details will be described later. In the present embodiment, the business negotiation is, for example, a business negotiation regarding vehicle sales, and the offering in the business negotiation is a vehicle, but there is no limitation on them. For example, the business negotiation may be a meeting for the purpose of concluding various types of contract, such as buying and selling real estate, signing insurance products, or selling financial products. In the present embodiment, the offering related to the business negotiation may be a product, a service, a digital content, a license, data or information, a financial product, real estate, an intangible asset, or any other tradable right. The business negotiation evaluation method according to the present embodiment is executed by the information processing device 10. First, the information processing device 10 acquires voice data related to a business negotiation. The information processing device 10 extracts, from the voice data, a duration of product explanation, a timing to acquire individual information about a customer in the business negotiation (hereinafter also referred to as “personal information”), details of questions asked when acquiring the personal information, and a timing to utilize the personal information for proposals during the business negotiation. The information processing device 10 calculates and presents information related to the duration and quantitative data related to the personal information.

As described above, according to the present embodiment, the information processing device 10 calculates and presents the information related to the duration and the quantitative data related to the personal information from the voice data related to the business negotiation. Therefore, quantitative evaluation information related to the business negotiation can be obtained automatically, and the business negotiation evaluation technology is improved in terms of improvement in objectivity and efficiency of evaluation.

Next, the configurations of the information processing device 10 and the terminal device 20 will be described in detail.

As shown in FIG. 1, the information processing device 10 includes a control unit 11, a storage unit 12, an input unit 13, an output unit 14, and a communication unit 15. The control unit 11 includes at least one processor. The processor may be a general-purpose processor such as a CPU, or a dedicated processor specialized for a specific process. The control unit 11 executes processes related to the operation of the information processing device 10 while controlling each unit of the information processing device 10. The storage unit 12 includes at least one semiconductor memory etc. The semiconductor memory is, for example, a RAM or a ROM. The storage unit 12 functions as, for example, a main storage device or an auxiliary storage device. The storage unit 12 stores data to be used in the operation of the information processing device 10 and data obtained by the operation of the information processing device 10. For example, the storage unit 12 stores a trained model. The trained model is created by machine learning using a machine learning algorithm. The trained model may be, for example, a machine learning model constructed based on a decision tree, or a model generated based on a machine learning algorithm such as a convolutional neural network (CNN), a recurrent neural network (RNN), or other deep learning. The input unit 13 includes at least one input interface. The input interface may be, for example, physical keys, a touch screen, a sound sensor that receives voice input, or a camera that receives gesture input. The input unit 13 receives an action to input data to be used in the operation of the information processing device 10. The output unit 14 includes at least one output interface. The output interface is, for example, a display that outputs information visually, or a speaker that outputs information audibly. The output unit 14 outputs data obtained by the operation of the information processing device 10. The communication unit 15 includes at least one external communication interface. The communication interface may be either a wired communication interface or a wireless communication interface. In the case of wired communication, the communication interface is, for example, a LAN or a USB. In the case of wireless communication, the communication interface is, for example, an interface compatible with mobile communication standards such as 5G, or an interface compatible with short-range wireless communication. The communication unit 15 receives data to be used in the operation of the information processing device 10 and transmits data obtained by the operation of the information processing device 10.

As shown in FIG. 1, the terminal device 20 includes a control unit 21, a storage unit 22, an input unit 23, an output unit 24, and a communication unit 25. The control unit 21 includes at least one processor. The processor may be a general-purpose processor such as a CPU, or a dedicated processor specialized for a specific process. The control unit 21 executes processes related to the operation of the terminal device 20 while controlling each unit of the terminal device 20. The storage unit 22 includes at least one semiconductor memory etc. The semiconductor memory is, for example, a RAM or a ROM. The storage unit 22 functions as, for example, a main storage device or an auxiliary storage device. The storage unit 22 stores data to be used in the operation of the terminal device 20 and data obtained by the operation of the terminal device 20. The input unit 23 includes at least one input interface. The input interface may be, for example, physical keys, a touch screen, a sound sensor that receives voice input, or a camera that receives gesture input. The input unit 23 receives an action to input data to be used in the operation of the terminal device 20. The output unit 24 includes at least one output interface. The output interface is, for example, a display that outputs information visually, or a speaker that outputs information audibly. The output unit 24 outputs data obtained by the operation of the terminal device 20. The communication unit 25 includes at least one external communication interface. The communication interface may be either a wired communication interface or a wireless communication interface. In the case of wired communication, the communication interface is, for example, a LAN or a USB. In the case of wireless communication, the communication interface is, for example, an interface compatible with mobile communication standards such as 5G, or an interface compatible with short-range wireless communication. The communication unit 25 receives data to be used in the operation of the terminal device 20 and transmits data obtained by the operation of the terminal device 20.

The functions of the information processing device 10 or the terminal device 20 are implemented by executing a program according to the present embodiment on a processor corresponding to the control unit 11 or the control unit 21. That is, the functions of the information processing device 10 or the terminal device 20 are implemented by software. The program causes a computer to execute the operation of the information processing device 10 or the terminal device 20, thereby causing the computer to function as the information processing device 10 or the terminal device 20. That is, the computer functions as the information processing device 10 or the terminal device 20 by executing the operation of the information processing device 10 or the terminal device 20 in accordance with the program. In the present embodiment, the program can be recorded on a computer-readable recording medium. The computer-readable recording medium includes a non-transitory computer-readable medium such as a magnetic recording device or a semiconductor memory. The program is distributed, for example, by selling, transferring, or lending a portable recording medium such as a DVD on which the program is recorded. The program may be distributed by storing the program in a storage of an external server and transmitting the program from the external server to other computers. The program may be provided as a program product. Part or all of the functions of the information processing device 10 or the terminal device 20 may be implemented by a dedicated circuit corresponding to the control unit 11 or the control unit 21. That is, part or all of the functions of the information processing device 10 or the terminal device 20 may be implemented by hardware.

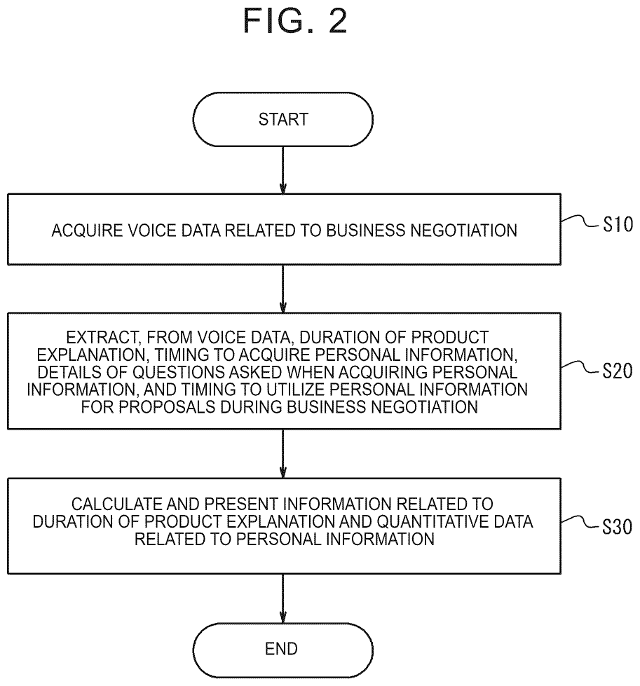

The operation of the information processing device 10 according to the present embodiment will be described with reference to FIG. 2. Description will mainly be given of an example in which the business negotiation is a business negotiation regarding vehicle sales and the offering in the business negotiation is a vehicle. First, the control unit 11 of the information processing device 10 acquires voice data related to a business negotiation (S10). Any method can be used to acquire the voice data related to the business negotiation. For example, the control unit 11 may acquire the voice data related to the business negotiation from an external device including the terminal device 20 via the communication unit 15 and the network 30. For example, the control unit 11 may acquire the voice data related to the business negotiation via the input unit 13.

Next, the control unit 11 extracts, from the voice data, a duration of product explanation, a timing to acquire personal information, details of questions asked when acquiring the personal information, and a timing to utilize the personal information for proposals during the business negotiation (S20). The personal information includes information on a family structure, a hobby, a daily lifestyle, a currently owned vehicle, income and expenditure trends, and a customer value. The information on the family structure includes information on a spouse, the presence or absence of a child, and the age range of the family. The information on the hobby includes information on preferences for driving, outdoor activities, sports, music, etc. The information on the daily lifestyle includes information on means for commuting, frequency, purposes of car use, etc. The information on the currently owned vehicle includes information on the model of the vehicle, years of use, the reason for replacement purchase, etc. The information on the income and expenditure trends includes information on a budget, whether a loan is used, etc. The information on the customer value includes information on priorities such as safety, fuel efficiency, and brand preference.

Any method can be used to extract such information. For example, the control unit 11 may input the voice data to a trained model to extract the duration of product explanation, the timing to acquire the personal information, details of the questions asked when acquiring the personal information, and the timing to utilize the personal information for proposals during the business negotiation.

Next, the control unit 11 calculates and presents information related to the duration of product explanation and quantitative data related to the personal information (S30). The information related to the duration of product explanation includes the ratio of the time spent on product explanation to the total time for the business negotiation. The quantitative data related to the personal information includes at least one of an acquisition rate related to the personal information and a utilization rate related to the personal information. The acquisition rate related to the personal information is an index showing the degree to which expected personal information to be acquired in the business negotiation was acquired in the business negotiation. For example, the acquisition rate related to the personal information may be determined by the following expression (1).

$$Expression ( 1 )$$

$$( Acquisition rate of personal information ) = \frac{( Personal information acquired in business negotiation )}{\begin{matrix}( Expected personal information to be acquired in \\ business negotiation )\end{matrix}} \qquad ( 1 )$$

The utilization rate related to the personal information is an index showing the degree to which the personal information acquired in the business negotiation was utilized directly or indirectly to propose products or services. Any criteria may be used to determine whether the personal information was utilized directly or indirectly to propose products or services. For example, determination may be made that the personal information was utilized directly or indirectly to propose products or services in the following cases.
A vehicle for a family with a child (e.g. minivan or SUV) was proposed based on the information on the family structure.
A four-wheel drive vehicle was proposed to a customer who enjoys outdoor activities based on the information on the hobby.
A fuel-efficient vehicle model was recommended based on the information on the lifestyle (e.g., commuting distance or frequency).
A proposal was made to emphasize the benefits of replacement purchase based on the information on the currently owned vehicle (e.g., years of use or frequency of malfunction).
A budget-priced vehicle and optimal loan terms were presented based on the income and expenditure trends.
A vehicle equipped with advanced safety features was introduced to a customer who places importance on safety performance based on the information on the customer value.

For example, the utilization rate related to the personal information may be determined by the following expression (2).

$$Expression ( 2 )$$

$$( Utilization rate of personal information ) = \frac{\begin{matrix}( Personal information utilized to propose products or \\ services )\end{matrix}}{( Personal information acquired in business negotiation )} \qquad ( 2 )$$

Any method can be used to present the information related to the duration of product explanation and the quantitative data related to the personal information. For example, the control unit 11 may transmit data to the terminal device 20 via the communication unit 15, and the information may be output by a user interface that is displayed and output by the output unit 24 of the terminal device 20. Alternatively, the control unit 11 may output the information on a user interface that is displayed and output by the output unit 14.

As described above, the information processing device 10 according to the present embodiment calculates and presents the information related to the duration and the quantitative data related to the personal information from the voice data related to the business negotiation. Therefore, quantitative evaluation information related to the business negotiation can be obtained automatically, and the business negotiation evaluation technology is improved in terms of improvement in objectivity and efficiency of evaluation.

Although the present disclosure has been described based on the drawings and examples, it should be noted that those skilled in the art may make various modifications and alterations based on the present disclosure. Therefore, it should be noted that these modifications and alterations are included within the scope of the present disclosure. For example, the functions included in the components or steps may be rearranged so as not to cause logical contradictions, and a plurality of components or steps may be combined or divided.

For example, the control unit 11 of the information processing device 10 may present the information related to the duration of product explanation and the quantitative data related to the personal information in a manner that they can be compared with corresponding information and quantitative data obtained by excellent sales staff members (hereinafter also referred to as “top performers”). Therefore, the sales staff member can compare his/her actions with those of the top performers and grasp specific points for improvement and effective approaches. By referring to indices based on the successful cases of the top performers, it is possible to expect improvements in the business negotiation skills of all the staff and an increase in the success rate of business negotiations.

For example, the control unit 11 of the information processing device 10 may present information related to the ratio of the time spent on product explanation and transition of the quantitative data in a plurality of past business negotiations conducted by an individual staff member. This allows the sales staff member to understand his/her business negotiation style and tendencies in explanation time, thereby easily finding the points for improvement and the approaches to success. Based on the past transition data, it is possible to learn the optimal time allocation for specific product explanation, thereby leading to expectation to improve the effectiveness of business negotiations.

For example, the quantitative data related to the personal information may include a natural conversation score. The natural conversation score is an index that evaluates how natural and smooth a conversation was during a business negotiation. For example, the natural conversation score may be determined based on openness of questions, relevance of questions, response from a customer, a count of questions, and variation of questions. The openness of questions may be an index in which the score increases as the ratio of open-ended questions increases. The relevance of questions may be an index in which the score increases as the questions are more relevant to the immediately preceding conversations. The response from a customer may be an index in which the score increases as the response is more positive. The count of questions may be an index in which the score increases as the number of questions asked to obtain necessary information decreases. The variation of questions may be an index in which the score increases as the number of different questions used to obtain the same information increases.

For example, in the above embodiment, the configuration and operation of the information processing device 10 may be distributed among a plurality of computers that can communicate with each other.

What is claimed is:

1. A business negotiation evaluation method to be executed by an information processing device, the business negotiation evaluation method comprising:
acquiring voice data related to a business negotiation;
extracting, from the voice data, a duration of product explanation, a timing to acquire personal information, details of questions asked when acquiring the personal information, and a timing to utilize the personal information for proposals during the business negotiation; and
calculating and presenting information related to the duration and quantitative data related to the personal information.

2. The business negotiation evaluation method according to claim 1, wherein the quantitative data related to the personal information includes at least one of an acquisition rate of the personal information and a utilization rate of the personal information.

3. The business negotiation evaluation method according to claim 2, wherein the acquisition rate of the personal information is calculated by weighting based on priority of the personal information to be acquired.

4. The business negotiation evaluation method according to claim 1, wherein the quantitative data related to the personal information includes a natural conversation score.

5. The business negotiation evaluation method according to claim 4, wherein the natural conversation score is determined based on openness of questions, relevance of questions, response from a customer, a count of questions, and variation of questions.
